(19) United States
(12) Patent Application Publication
(10) Pub. No.: US 2015/0206673 A1
(43) Pub. Date: Jul. 23, 2015

(54) THIN-TYPE KEYBOARD STRUCTURE

(71) Applicant: Chicony Electronics Co., Ltd., New Taipei City (TW)

(72) Inventors: CHIH-HUNG LIN, New Taipei City (TW); CHENG-KANG PENG, New Taipei City (TW); CHIH-HSIANG HSU, New Taipei City (TW)

(21) Appl. No.: 14/508,886

(22) Filed: Oct. 7, 2014

(30) Foreign Application Priority Data
Jan. 17, 2014 (TW) 103101781

(51) Int. Cl. H01H 13/704

(52) U.S. Cl. CPC H01H 13/704; H01H 2227/036

(57) ABSTRACT

A thin-type keyboard structure includes a substrate, a membrane circuit board, a key assembly and a signal conversion module. The membrane circuit board is disposed on the substrate and includes a plurality of signal wires. The key assembly includes a plurality of normal keys, a plurality of specific keys and a predetermined key. The signal conversion module is disposed on membrane circuit board and electrically connected to the signal wires, wherein the predetermined key correspondingly covers the signal conversion module.

### CROSS-REFERENCES TO RELATED APPLICATIONS

This non-provisional application claims priority under 35 U.S.C. §119(a) on Patent Application No. 103101781 filed in Taiwan, R.O.C. on 2014 Jan. 17, the entire contents of which are hereby incorporated by reference.

### BACKGROUND

1. Technical Field

The disclosure relates to a keyboard assembly, and particularly to a thin-type keyboard structure.

2. Related Art

Accompanying the continuous progress of related technologies, not only have computer software interfaces improved, but also the hardware interfaces thereof. A newly market-available keyboard supports serial port transmission interfaces, which are advantageous in the optimization of the computer system's power management, the uniformization of the connection ways of the peripheral apparatuses, and the reduction of the number of pins of the connecting interfaces. In architectures of a laptop computer, a conventional keyboard structure which is serial port transmission interface supportable is disclosed, as shown in FIG. 1, and is substantially embodied by externally connecting a membrane circuit board 1 with a signal conversion circuit board 5, wherein the signal conversion circuit board 5 has a microprocessor 6 to convert the keyboard scan signals into signals compatible with the serial interface and transmits to the computer. Specifically, keyboard scan wirings 2 of the membrane circuit board 1 are collected and connected electrically to the microprocessor 6 of the signal conversion circuit board 5 via a first flat cable 3 and a connector 4. After the keyboard scan signals are converted by the microprocessor 6, the converted signals are transmitted to the computer via a second flat cable 7.

Additionally, the configuration of the conventional keyboard structure is disclosed, as shown in FIG. 2, in which the membrane circuit board 1 is disposed on the substrate 8, and the signal conversion circuit board 5 is disposed and fastened with the bottom face of the substrate 8 by bending the first flat cable 3 thereby benefitting the manufacturing. However, such conventional keyboard has some problems, described in the following paragraphs.

Firstly, conventionally, although the first flat cable 3 and the membrane circuit board 1 are designated to be formed integrally to simplify the manufacturing processes and to improve the product yield, the profile of the membrane circuit board 1 will be irregular along with the generation of waste materials during cutting processes, thus resulting in extra manufacturing cost.

Secondly, notebook computers have developed a light-and-thin trend; while in the conventional keyboard structure, the signal conversion circuit board 5 is disposed at the bottom face of the substrate 8, thereby not only increasing the overall thickness of the conventional keyboard structure, but also reducing the available space for assembling other components.

Consequently, improving the structure of the conventional keyboard structure is an urgent matter for persons skilled in the art to address.

### SUMMARY

In view of this, the disclosure provides a thin-type keyboard structure including a substrate, a membrane circuit board, a key assembly and a signal conversion module. The membrane circuit board is disposed on the substrate and includes a plurality of signal wires. The key assembly includes a plurality of normal keys, a plurality of specific keys and a predetermined key. The normal keys, the specific keys and the predetermined key are pressably disposed on the membrane circuit board, respectively. The signal conversion module is disposed on the membrane circuit board and connected electrically to the signal wires. The predetermined key covers the signal conversion module correspondingly.

A linked structure is disposed between the key assembly and the membrane circuit board, and the linked structure includes a cross-type connecting member and a rubber dome.

Furthermore, there are several implementations of the predetermined key; for example, the predetermined key can be bar shaped and aligned along a left-and-right direction; the cross-type connecting member is disposed at left and right sides of the predetermined key, the rubber dome is disposed at a middle portion of the predetermined key, and the signal conversion module is disposed between the cross-type connecting member and the rubber dome. Alternatively, the predetermined key is bar shaped and aligned along an up-and-down direction; the cross-type connecting member is disposed at upper and lower sides of the predetermined key, the rubber dome is disposed at the middle portion of the predetermined key, and the signal conversion module is disposed between the cross-type connecting member and the rubber dome.

Based on this, according to the present invention, the signal conversion module is combined with the membrane circuit board with the predetermined key correspondingly covered the signal conversion module, thereby the residual spaces between the predetermined key and the membrane circuit board can be utilized effectively. Based on this, the keyboard structure is thinning without reducing the available spaces for assembling other components in the premise of compiling with the serial transmission interface. Additionally, the flat cable for connecting the connector and the membrane circuit board can be reduced, thereby lowering the manufacturing cost.

Additionally, according to the present invention, the membrane circuit board can be a simple geometrical shape (as shown in the figures, the membrane circuit board is rectangular in shape), so that waste materials are not generated during the cutting processes, thereby improving the material utilization rate and reducing the manufacturing cost.

The detailed features and advantages of the disclosure are described below in great detail through the following embodiments, the content of which is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is a plan view showing a conventional keyboard structure in which a membrane circuit board is externally connected to a signal conversion circuit board;

FIG. 2 is a partial cross-sectional view of the conventional keyboard structure;

FIG. 3 is an exploded view of a thin-type keyboard structure in accordance with the present invention;

FIG. 4 is a top view of the thin-type keyboard structure of the present invention;

FIG. 5 is a perspective view showing a predetermined key is correspondingly disposed on a signal conversion module of the present invention;

FIG. 6 is a partial cross-sectional view of the thin-type keyboard structure of the present invention;

FIG. 7 is a plan view showing a different implementation of the predetermined key according to the present invention; and

FIG. 8 is a plan view showing another different implementation of the predetermined key according to the present invention.

### DETAILED DESCRIPTION

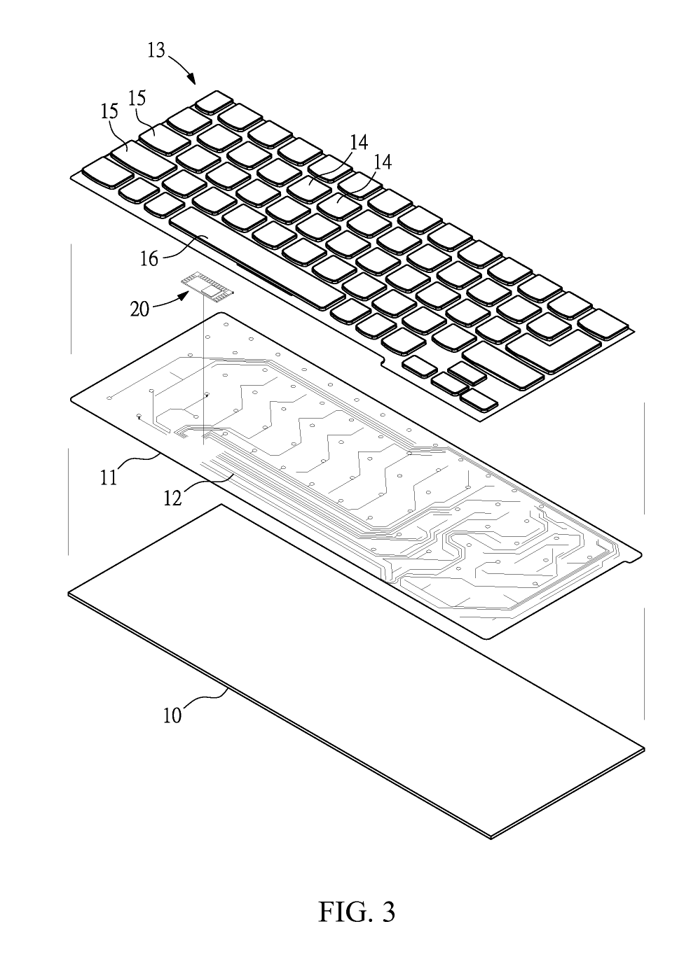

Please refer to FIG. 3, in which a thin-type keyboard structure is illustrated. The thin-type keyboard structure includes a substrate 10, a membrane circuit board 11, a key assembly 13 and a signal conversion module 20.

The membrane circuit board 11 is disposed on the substrate 10 and includes a plurality of signal wires 12. The membrane circuit board 11 can be formed by multi-layered plastic membranes, and the signal wires 12 are configured on the membrane circuit board 11 via printing techniques.

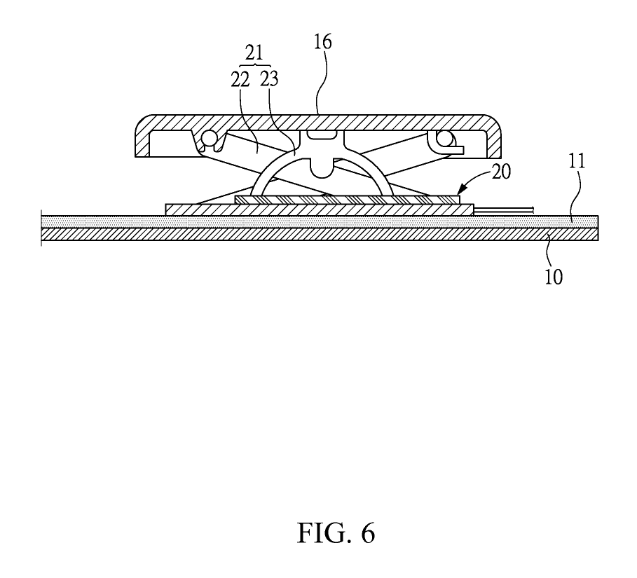

The key assembly 13 includes a plurality of normal keys 14, a plurality of specific keys 15 and a predetermined key 16. The normal keys 14, the specific keys 15 and the predetermined key 16 are pressably disposed on the membrane circuit board 11, respectively. Please refer to FIG. 6, in which each key of the key assembly 13 is pressably disposed on the membrane circuit board 11 via a linked structure 21; the linked structure 21 includes a cross-type connecting member 22 and a rubber dome 23, so that when a user presses the key of the key assembly 13, the signal wires 12 of the membrane circuit board 11 can be conducted to generate signals.

The signal conversion module 20 is disposed on the membrane circuit board 11 and connected electrically to the signal wires 12. The predetermined key 16 correspondingly covers the signal conversion module 20.

The signal conversion module 20 can include a signal circuit board and a micro control unit (MCU); the signal circuit board can be a printed circuit board or a flexible printed circuit. As shown in FIG. 3, the signal conversion module 20 is disposed at the surface of the membrane circuit board 11 to connect electrically to the signal wires 12. The connection between the signal conversion module 20 and the membrane circuit board 11 can be accomplished by anisotropy conductive gluing or hotbar process. And, as shown in FIG. 6, the border width of the signal conversion module 20 can be smaller than the border width of the predetermined key 16, so that the user will not contact or press the signal conversion module 20 upon pressing the predetermined key 16.

Furthermore, the signal conversion module 20 can be a plastic membrane printed circuit board, and the signal conversion module 20 and the membrane circuit board 11 are integrally formed as one circuit board.

The scan signals generated by the membrane circuit board 11 can be converted, through the signal conversion module 20, into signal formats which can be supported by serial interfaces, thereby allowing the diversity of the computer interfaces.

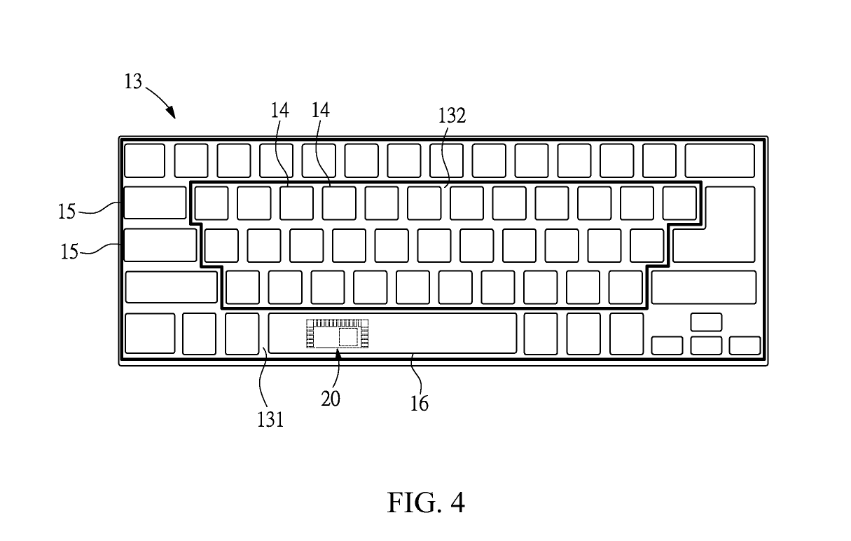

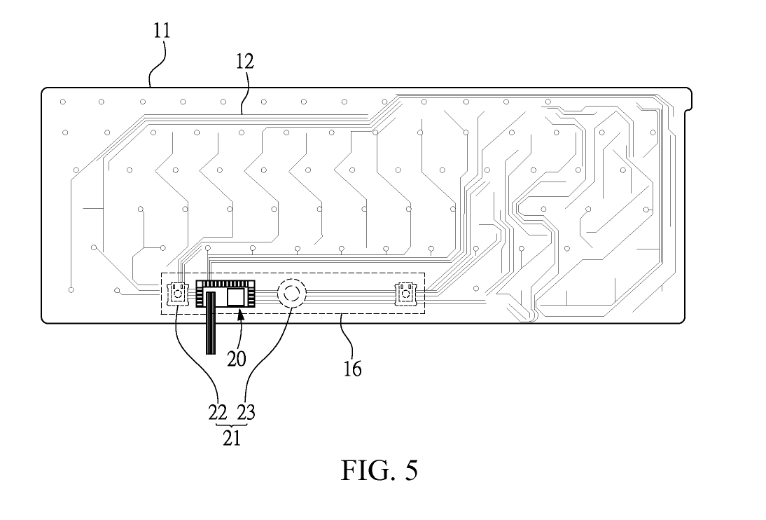

Please refer to FIG. 5, in which the signal conversion module 20 can be connected to the motherboard of the computer via a signal output circuit so as to transmit the converted signals. The signal output circuit can be a flex flat cable, a flexible printed circuit or a terminal cable. Furthermore, as shown in FIG. 4, the key assembly 13 includes a peripheral region 131 and a central region 132, and the predetermined key 16 is disposed at the peripheral region 131, thereby allowing easier configuration of the signal output circuit.

The normal keys 14 of the key assembly 13 can be keys with a smaller area, such as alphabet keys (A, B, C, D . . . ), number keys (1, 2, 3, 4 . . . ), and the like. The specific keys 15 can be function keys the area of which is larger than the normal keys 14, such as Tab button, Caps Lock button, Shift button, Ctrl button, Windows button, Space button, Enter button, Backspace button or the like. The predetermined key 16 is one of the specific keys 15, and as described in the following paragraphs.

Please refer to FIG. 4 and FIG. 5, in which embodiment, the predetermined key 16 is the Space button. Since a larger space is formed between the Space button and the membrane circuit board 11, the signal conversion module 20 can be assembled therein conveniently, but embodiments are not thus limited thereto; in some implementation aspects, the predetermined key 16 can be another function key. Different configurations of the implementation of the predetermined key 16 and the signal conversion module 20 are described as following.

As shown in FIG. 5, in which the predetermined key 16 is bar shaped and aligned along a left-and-right direction, in this embodiment, the predetermined key 16 is the Space button, but embodiments are not thus limited thereto; in some implementation aspects, the predetermined key 16 can be Tab button, Caps Lock button, Shift button or the like. The cross-type connecting member 22 is disposed at left and right sides of the predetermined key 16, the rubber dome 23 is disposed at a middle portion of the predetermined key 16, and the signal conversion module 20 is disposed between the cross-type connecting member 22 and the rubber dome 23.

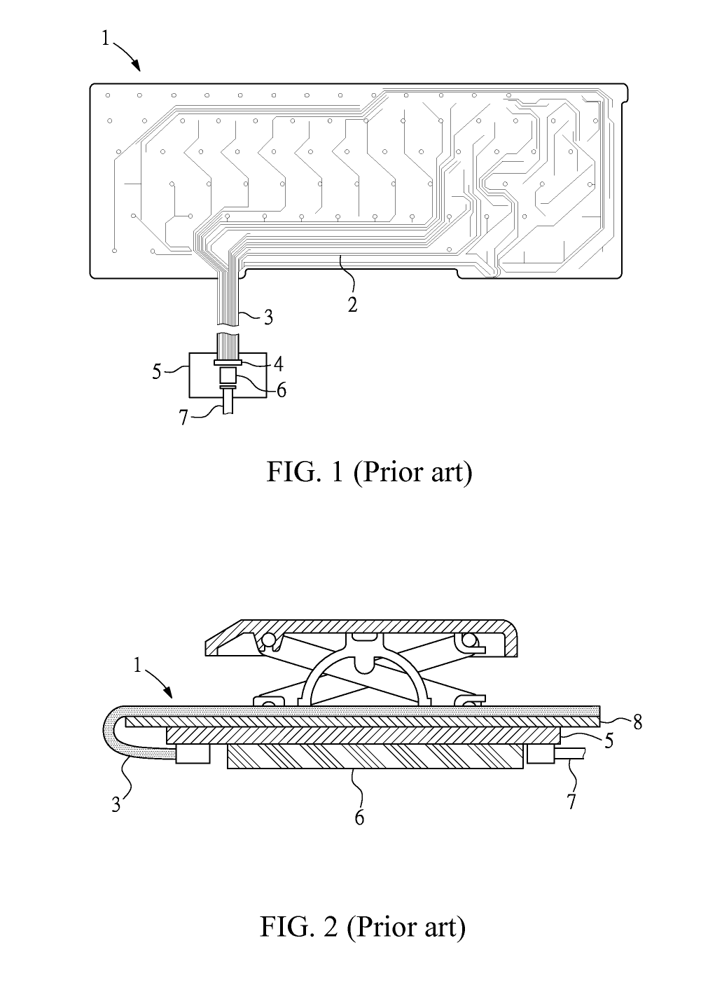

As shown in FIG. 6, a partial cross-sectional view of the thin-type keyboard structure is illustrated. According to the present invention, the signal conversion module 20 is disposed at the space between the predetermined key 16 and the membrane circuit board 11, thereby reducing the overall thickness significantly in comparison with the conventional keyboard structure shown in FIG. 2. Based on this, the thickness of the keyboard structure can reduced, while supporting serial interface transmission requirements.

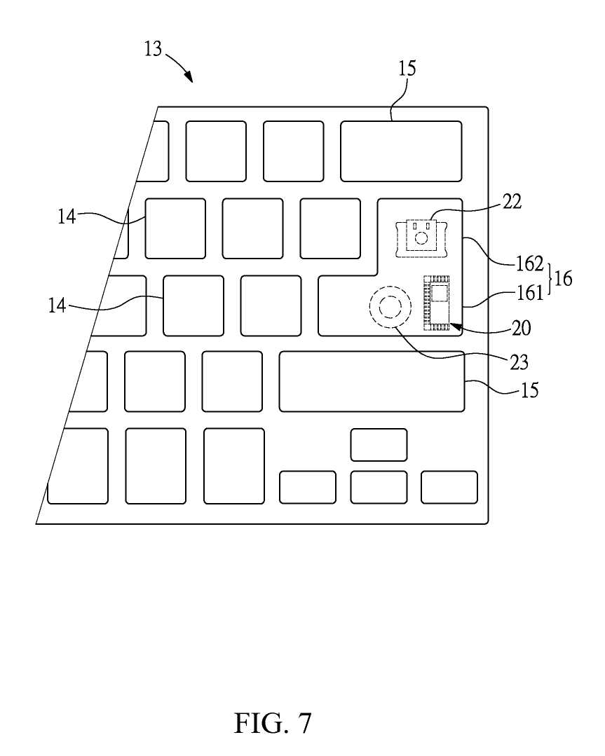

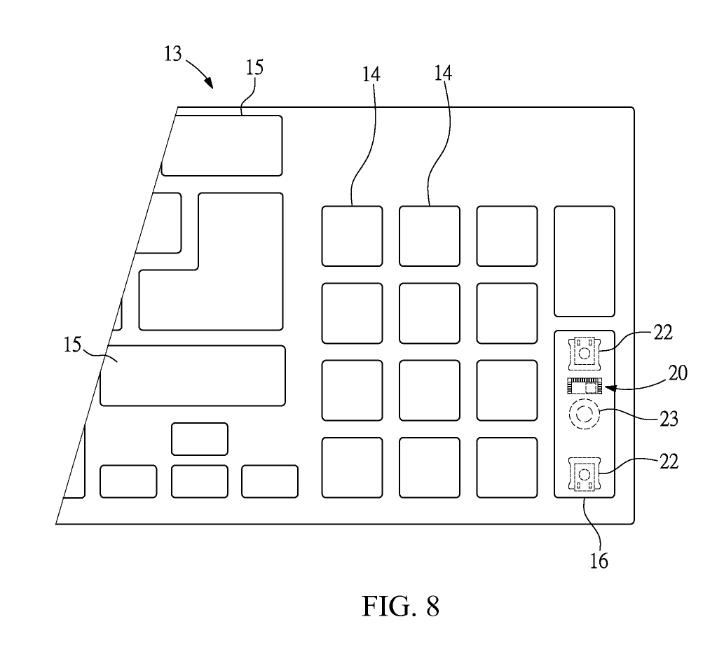

As shown in FIG. 7, in which the predetermined key 16 includes a body 161 and an extending portion 162 in which the body 161 and the extending portion 162 are connected with each other; for example, in some implementation aspects, the Enter button is L-profiled. The signal conversion module 20 can be disposed below the body 161 or below the extending portion 162; in this embodiment, the signal conversion module 20 is disposed below the body 161; that is the signal conversion module 20 is covered by the body 161.

As shown in FIG. 8, the predetermined key 16 is bar shaped and aligned along an up-and-down direction. For example, in a notebook computer with larger size, a numerical key assembly is further disposed on the right part of the keyboard thereof. The cross-type connecting member 22 is disposed at upper and lower sides of the predetermined key 16, the rubber dome 23 is disposed at a middle portion of the predetermined key 16, and the signal conversion module 20 is disposed between the cross-type connecting member 22 and the rubber dome 23.

Additionally, note that implementations of the predetermined key 16 and the positional configurations between the cross-type connecting member 22, the rubber dome 23 and the signal conversion module 24 provided herein are not thus limited, and examples described here are for illustrative purposes only. It should be emphasized that, any modification or variation of the profiles and the configurations are within the scope of the technical feature of the present invention.

Based on this, according to the present invention, the signal conversion module is combined with the membrane circuit board with the predetermined key correspondingly covered the signal conversion module; thereby the residual spaces between the predetermined key and the membrane circuit board can be utilized effectively. Based on this, the keyboard structure thickness is reduced without reducing the available space for assembling other components under the serial transmission interface requirements. Additionally, the flat cable for connecting the connector and the membrane circuit board can be reduced, thereby lowering the manufacturing cost.

Additionally, according to the present invention, the membrane circuit board can be simple geometrical shape, (as shown in the figures, the membrane circuit board is rectangular shape), so that waste materials are not generated during cutting processes, thereby improving the material utilization rate and reducing the manufacturing cost.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A thin-type keyboard structure, comprising:
a substrate;
a membrane circuit board, disposed on the substrate and comprising a plurality of signal wires;
a key assembly, comprising a plurality of normal keys, a plurality of specific keys and a predetermined key, wherein the normal keys, the specific keys and the predetermined key are pressably disposed on the membrane circuit board, respectively; and
a signal conversion module, disposed on the membrane circuit board and connected electrically to the signal wires, wherein the predetermined key correspondingly covers the signal conversion module.

2. The thin-type keyboard structure according to claim 1, wherein the predetermined key is one of the specific keys.

3. The thin-type keyboard structure according to claim 1, wherein a border width of a signal conversion module is smaller than a border width of the predetermined key.

4. The thin-type keyboard structure according to claim 1, wherein the key assembly further comprises a peripheral region and a central region, the predetermined key is disposed at the peripheral region.

5. The thin-type keyboard structure according to claim 1, further comprising a linked structure disposed between the key assembly and the membrane circuit board, and the linked structure comprising a cross-type connecting member and a rubber dome.

6. The thin-type keyboard structure according to claim 5, wherein the predetermined key is bar shaped and aligned along a left-and-right direction, the cross-type connecting member is disposed at left and right sides of the predetermined key, the rubber dome is disposed at a middle portion of the predetermined key, and the signal conversion module is disposed between the cross-type connecting member and the rubber dome.

7. The thin-type keyboard structure according to claim 5, wherein the predetermined key is bar shaped and aligned along an up-and-down direction, the cross-type connecting member is disposed at upper and lower sides of the predetermined key, the rubber dome is disposed at a middle portion of the predetermined key, and the signal conversion module is disposed between the cross-type connecting member and the rubber dome.

8. The thin-type keyboard structure according to claim 5, wherein the predetermined key further comprises a body and an extending portion, and the signal conversion module is disposed below the body or below the extending portion.

9. The thin-type keyboard structure according to claim 1, wherein the signal conversion module is assembled on a surface of the membrane circuit board.

10. The thin-type keyboard structure according to claim 1, wherein the signal conversion module is a plastic membrane printed circuit board, and the signal conversion module and the membrane circuit board are integrally formed as one circuit board.
